(19) United States
(12) Patent Application Publication
(10) Pub. No.: US 2002/0178222 A1
(43) Pub. Date: Nov. 28, 2002

(54) Information duplication and customization system and method for handheld computers

(75) Inventors: Sean O'Hara, Foster City, CA (US); Brian Torrey, San Mateo, CA (US); Patricia E. Duenas, San Mateo, CA (US)

Correspondence Address: Alistair K. Chan, FOLEY & LARDNER, Firstar Center, 777 East Wisconsin Avenue, Milwaukee, WI, 53202-5367, US

(73) Assignee: Palm, Inc.

(21) Appl. No.: 09/865,013

(22) Filed: May 24, 2001

(51) Int. Cl. G06F 15/16

(52) U.S. Cl. 709/205

(57) ABSTRACT

A method and system for transmitting common information to a plurality of recipients using a handheld computer is provided. An electronic document is automatically generated including the common information. Customized information may be inserted in the electronic document based on the intended recipient.

### BACKGROUND

Handheld computing devices, “palmtops,” “palmhelds,” personal digital assistants (PDAs), or handheld computers typically weigh less than a pound and fit in a pocket. These handhelds generally provide some combination of personal information management, database functions, word processing, and spreadsheets as well as voice memo recording, wireless e-mail, and wireless telephony functions. Because of the small size and portability of handhelds, strict adherence to hardware constraints such as memory and processor size must be maintained.

Handheld computers may include programs or modules which allow a user to send electronic files to remote locations, such as other handheld computers, personal computers, printers, pagers and World Wide Web sites. One example of sending an electronic file to a remote location would be the sending of an electronic mail (e-mail) document.

In certain situations it may be desirable to transmit an electronic document to multiple remote locations. With regard to e-mail messages, this is conventionally accomplished by entering multiple recipient addresses in a recipient field in an e-mail program. When an e-mail is sent using this method, an identical copy of the e-mail message is forwarded to each recipient.

It may be desirable to customize an electronic document based on the intended recipient of the document. For example, a manager may wish to send a copy of the most recent meeting minutes to individual attendees, with specific comments or action items appended to the minutes for each attendee. In another situation, a salesperson may wish to send portions of an internal memorandum to several clients, along with explanatory notes and individualized price quotations.

Traditionally, the method for customizing and sending an electronic document to various recipients has involved copying information from a document already in existence, creating a new document, and pasting the selected portion into the new document. One disadvantage of using this method is that copying information from a document involves storing the copied information in a separate file, sometimes referred to as a clipboard file.

Clipboard files typically have a limited maximum capacity for storing electronic information. Particularly in the context of handheld computers, the size of the clipboard limits the ability to efficiently copy information from one document to another. If the quantity of information selected by the user is too large, a portion of the information will not be copied to the clipboard. A user must then paste the clipboard information into the new document, return to the original document, locate the point at which copying ended, copy additional information not previously copied, and paste this information into the new document at the appropriate location. Depending on the amount of information to be copied, this procedure may need to be repeated several times for a single new document. Users wishing to customize a document to be sent to several recipients would have to repeat this procedure for each new document.

An alternative to repeatedly copying and pasting information involves creating a document template and saving it to a location in the permanent memory of the handheld computer. The user must then retrieve the document from the permanent memory, customize it by adding or deleting information based on the intended recipient, save it as a new document, and forward the new document to the recipient. In the context of an e-mail message, this procedure would involve sending a first e-mail to a recipient, retrieving a copy of the message from a storage location such as an “Outbox” file folder, modifying the message, and sending it to another recipient. This method would then be repeated a number of times, depending on the number of intended recipients.

Each step in this alternative method may in turn involve several steps. For instance, to save a document, a user typically must select the “save” option from a menu, choose a storage location for the new message, enter a name for the new file, and affirm the choice to save the document by selecting “finish,” “done,”or a similar option. To retrieve a previously sent e-mail message, a user typically would select a file folder containing sent messages, parse the information in the file folder to locate the relevant message, and open the message by either highlighting the message or entering message identification information.

Users of handheld computers value the convenience and portability that handheld computers provide. To send customized documents or messages to multiple recipients, however, a user must rely on inconvenient, inefficient, and time-consuming methods such as those described above.

Thus, there is a need to provide a more efficient method of using a handheld computer to create and deliver electronic documents and messages that are customized based on the intended recipient. There is a further need to provide a method of using a handheld computer to create and deliver customized electronic documents and messages that does not involve manually copying common information from one electronic file to another or storing common information in a temporary file such as a clipboard. There is still a further need to provide a method of using a handheld computer to create and deliver customized electronic documents and messages that involves fewer steps than methods typically used. There is yet a further need to provide a handheld computer system that allows a user to send customized documents and messages to multiple recipients in a more efficient manner that does not involve manually copying or temporarily storing common information in a clipboard file.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the above-mentioned needs.

### SUMMARY

An exemplary embodiment relates to a method of sending common information to multiple destination sources using a handheld computer. The method includes selecting information in a source file, storing the selected information, and selecting a remote destination. The method also includes adding destination-specific information to the selected information and sending both the selected and destination-specific information to the remote destination.

Another exemplary embodiment relates to a method of customizing information contained in an electronic file using a handheld computer based on the intended recipient of the information. The method includes selecting information in a first electronic document and automatically generating a second electronic document. The second electronic document includes the information selected from the first electronic document. The method further includes choosing an output destination for the second electronic document, adding customized information to the second electronic document, and delivering the second electronic document to the output destination.

Yet another exemplary embodiment relates to a method of conveying electronic information to members of a defined group using a handheld computer. The method includes creating a distribution group including a plurality of recipients. The method also includes generating a first electronic file including common information to be sent to at least one of the plurality of recipients. The method further includes choosing a first recipient from the plurality of recipients in response to a user prompt, entering a first customized set of information in the electronic file tailored to the first recipient, and sending both the common and first customized set of information to the first recipient.

Yet still another exemplary embodiment relates to a handheld computer including a processor. The handheld computer also includes a display and a memory coupled to the processor. The handheld computer further includes a program running on the processor, where the program is configured to enable a user to create an electronic template document having a first set of information. The program is also configured to automatically transfer the first set of information into at least one destination-specific document and enabling the entry of destination-specific information into the at least one destination-specific document.

Alternative exemplary embodiments relate to other features and combination of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an exemplary front elevation view of a handheld computer;

FIG. 2 is an exemplary perspective view of a handheld computer and a battery charging cradle;

FIG. 3 is a flow diagram representative of an exemplary embodiment of a method for sending customized information to multiple recipients;

FIG. 4 is a flow diagram representative of the flow of information according to the exemplary embodiment illustrated in FIG. 3; and

FIG. 5 is a flow diagram representative of another exemplary embodiment of a method for sending customized information to multiple recipients.

### DETAILED DESCRIPTION OF EXEMPLARY EMBODIMENTS

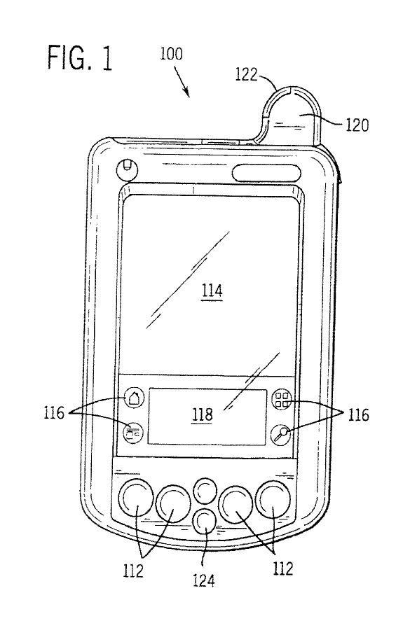

Referring to FIG. 1, a handheld computer 100 is depicted according to an exemplary embodiment. Handheld computer 100 may include Palm style computers manufactured by Palm, Inc., of Santa Clara, Calif. Other exemplary embodiments may include Windows CE handheld computers, or other handheld computers and personal digital assistants, as well as mobile telephones, pagers, and other mobile computing devices.

Preferably, handheld computer 100 includes interactive hardware and software that performs functions such as maintaining calendars, phone lists, task lists, note pads, calculator applications, spreadsheets, games, video files, and other applications capable of running on a computing device. Further, handheld computer 100 may be configured for such functions as voice memo recording and playback as well as communications network connectivity, Internet connectivity, wireless messaging, e-mail, always-on e-mail, and wireless telephony.

Handheld computer 100, depicted in FIG. 1, includes a plurality of input function keys 112 and a display 114 having graphical user interface features. Display 114 may be provided with a touch screen interface that allows a user to select and alter displayed content using a pointer, such as but not limited to a stylus, a pen tip, a fingertip, or other pointing devices.

Referring again to FIG. 1, in an exemplary embodiment, display 114 also includes a Graffiti™ (or other handwriting recognition software) writing section 118 for tracing alpha-numeric characters as input. A plurality of input icons 116 for performing automated or preprogrammed functions may be provided on a portion of display 114.

In an exemplary embodiment, handheld computer 100 may include an integrated antenna 120 configured to transmit and receive wireless communication signals, such as, but not limited to, cellular telephone communication signals and other radio frequency (RF) communications signals using an RF transceiver. Antenna 120 may further include an indicator light 122 integrated into antenna 120 for indicating the transmission and reception of wireless communication signals. Further, light 122 may be used to indicate other states of handheld computer 100.

In an exemplary embodiment, handheld computer 100 also includes navigation buttons 124 that may be utilized for navigating or scrolling of information displayed on display 114. Further, navigation buttons 124 may be programmed for other uses depending on the application running on handheld computer 100. Handheld computer 100 may be used for any of a variety of wireless communications, including, but not limited to, communications with the World Wide Web, mobile telephone communications, e-mail communications, etc.

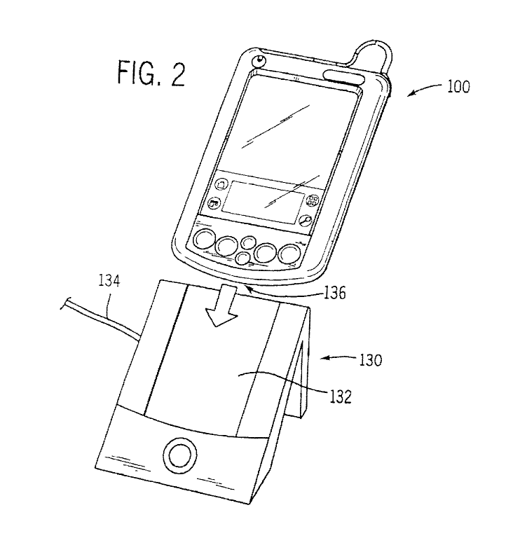

Referring to FIG. 2, in an exemplary embodiment, handheld computer 100 may be coupled to a cradle, such as a synchronization cradle 130. Cradle 130 may be used for synchronizing data between handheld computer 100 and a personal computer and/or may be used for providing power to handheld computer 100 for powering handheld computer 100 or for recharging a rechargeable power source in handheld computer 100. Cradle 130 may include a platform 132 configured to receive handheld computer 100, and a power and/or data cord 134 (which, in an exemplary embodiment may be, but is not limited to a universal serial bus (USB) cord) that may be coupled to a personal computer and optionally to a wall outlet to supply power to cradle 130. Alternatively, cradle 130 may draw power through the data cord from the personal computer.

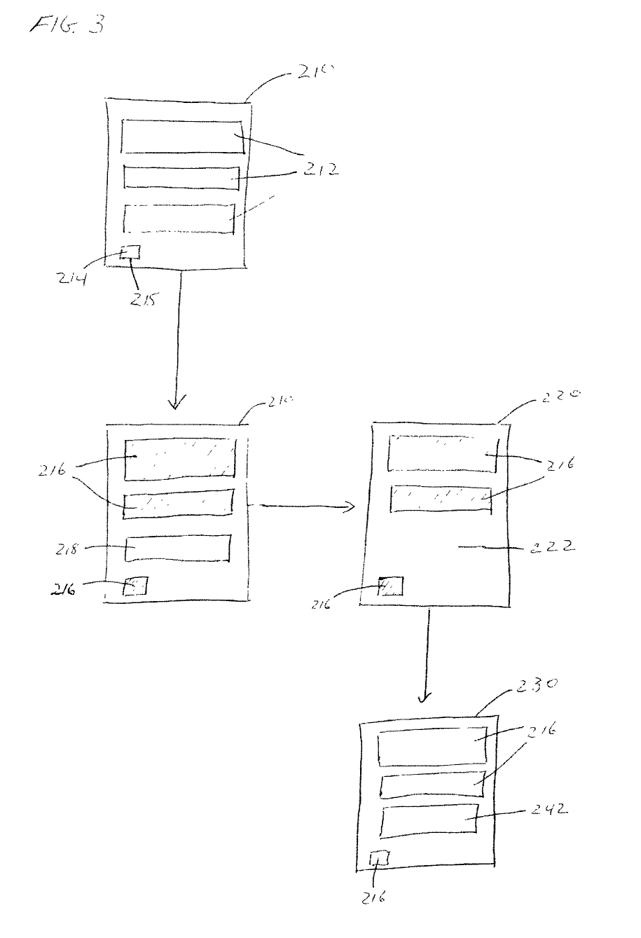

FIG. 3 is a flow diagram representative of an exemplary embodiment of a method for sending customized information to multiple recipients. A document depicted as a source file 210 may be stored in handheld computer 100, and may be any type of electronic document, such as audio, video, image, spreadsheet, database, presentation, text document, and scanned image or text files. In an exemplary embodiment, source file 210 is an electronic mail message.

Source file 210 includes information 212, such as electronic text, images, or other graphical representations. Information 212 may also include one or more electronic file attachments 214, which may be any type of electronic document. Electronic file attachments 214 may be represented in source file 210 by an icon or other image 215. In an exemplary embodiment, source file 210 is an electronic mail (e-mail) message including electronic text and an attached spreadsheet file.

Source file 210 and electronic file attachments 214 need not be created by the user of the handheld computer 100, and may be transferred or uploaded to the handheld computer 100 using any acceptable method. For instance, source file 210 may be created on a remote computer and transferred to handheld computer 100 by means of the Internet, wireless telephony, electronic mail, infrared or RF transmission, or by synchronization cradle 130. Additionally, source file 210 may be a physical document that is scanned into handheld computer 100 or into another computer using a scanner and/or an optical character recognition (OCR) program.

After source file 210 is created, a user may mark certain information in the source file 210 as common or selected information 216. Common information 216 is information that will be transferred in identical form to at least one new electronic document. Non-common or non-selected information 218 is information in source file 210 that will not be transferred to a new electronic document. As illustrated in FIG. 3, common information 216 in source document 210 will appear different from the non-common information 218. In an exemplary embodiment, common information 216 will appear with a gray color tint. In other exemplary embodiments, common information 216 may be a different color than non-common information 218, highlighted with a different background, bolded, italicized, have a different type specification, or have any other differing characteristic that will allow a user to view information 212 and instantly determine which information is common information 216. Additionally, in another exemplary embodiment, it may be desirable for non-common information 218 to have a different appearance. In that case, common information 216 would retain its original appearance.

Common information 216 may be selected by a user in any appropriate manner. For example, a user may draw a line circumscribing or otherwise delineating the common information 216 using a stylus, pen, finger, or other pointing device. A user might also delineate a portion of text by drawing a vertical line on one side of the portion of text, or by drawing a horizontal line before and after the portion of text, or by any other equivalent means. Alternatively, a user may underline or highlight the information using a pointing device or another input device, such as input function keys 112 or other input tools included in handheld computer 100. The user may also mark common information 216 by deleting non-common information 218, leaving a source file including only common information 216. In an exemplary embodiment, users mark common information 216 by tagging it, in which the user inserts a bracket or some other symbol at the beginning and end of common information 216. In another exemplary embodiment, a user could mark all information 212 in source file 210 and deselect non-common information 218 by marking it in an appropriate manner. In yet another exemplary embodiment, the user could mark only non-common information 218, leaving only common information unselected.

After common information 216 is selected in source file 210, a new customizable file or document 220 is automatically generated. Customizable file 220 may be any type of electronic document, and contains only common information 216 selected from source file 210. Common information 216 in customizable file 220 may or may not retain the differing appearance it had in source file 210. As shown in the exemplary embodiment of FIG. 3, common information 216 retains the differing appearance. In an exemplary embodiment, customizable file 220 is the same type of electronic document as source file 210. For example, both source file 210 and customizable file 220 may be e-mail messages. In an alternative embodiment, customizable file 220 may be a different type of electronic document than source file 210. In this alternative embodiment, a prompt would appear on the handheld computer screen 114 prior to the creation of the customizable file 220 asking the user to choose from a list of document types. Alternatively, customizable file 220 may be created as the same type of document as source file 210, and a user may later choose to convert customizable file 220 to another document type.

The automatic generation of customizable file 220 utilizes the dynamic memory of handheld computer 100. Rather than force a user to copy information to a clipboard file, create a new document, and paste the information into the new document, information selected by the user from the source file 210 is automatically stored in the memory of handheld computer 100. Customizable file 220 is then automatically generated containing information transferred from the memory to the new document. One advantageous feature of automatically generating a customizable file 220 is that steps are eliminated from methods typically employed in creating customized documents and messages intended for varied recipients. By automatically generating a customizable file 220, there is no need to manually copy information from a source file to a new document or to use limited clipboard space to do so. Another advantageous feature is that the automatic generation may be utilized to create multiple documents without having to return to the source file 210. Thus, when a user finishes with one customizable file 220, the user may create another customizable file that automatically includes the same common information 216 as was selected in creating customizable file 220.

Once customizable file 220 has been created, a user may enter additional or customized information 242. When customizable file 220 is created, there may be blanks or spaces 222 in place of the non-common information in source file 210. A user may then enter customized information 242 in blanks 222 or anywhere in customizable file 220. The customized information 242 may be tailored to a specific individual or group of individuals, and may include electronic text, attached electronic documents or files, and any other electronic information. After adding customized information, customizable file 220 includes both common information 216 from source file 210 and customized information 242. The result is customized document or file 230, which may be sent to an intended recipient in final customized form. Note that to the viewer of customized file 230, both common information 216 and customized information 242 appear identical. Thus, a viewer cannot tell which information 212 was sent to other recipients and which information 212 was tailored to the recipient. In an alternative embodiment, common information 216 could appear different from the customized information 242. In an exemplary embodiment, source file 210 and customizable file 220 are both electronic mail messages, and customized information 242 is electronic text entered by a user in customizable file 220.

In an exemplary embodiment, at least a portion of customized information 242 may be automatically generated. In this embodiment, customizable file 220 would be created with common information 216 and a portion of customized information 242 would automatically be inserted in customizable file 220. The user may then provide additional customized information 242 in customizable file 220. As an example, an individual may wish to send confidential information to a number of sources. The individual would select common information in a source file, and a new customizable file 220 would be generated including both common information 216 and a predetermined notice of confidentiality. The individual may then provide specific comments in customizable file 220. In yet another alternative embodiment, the automatically-generated customized information 242 may be varied depending on the recipient. Thus, in the above example, a highly detailed confidentiality notice may be included in the case of an external recipient, while a less detailed reminder notice may be included for an internal recipient.

Customizable file 220 may be sent to at least one intended recipient, group of intended recipients, or storage location at a particular output destination. The output destination may be either a remote location or a storage location within handheld computer 100. Remote locations may also include one or more of a fax machine, a pager, an e-mail account, a printer, a cellular phone, another handheld computer, a personal computer, an Internet or World Wide Web address, or any other suitable location outside handheld computer 100.

Those of skill in the art will recognize that the order of the above steps may be altered without departing from the scope of the described embodiments. Thus, the output destination may be chosen at any point prior to, during, or after the creation of customizable file 220. In an exemplary embodiment, the user is prompted to enter an output destination by selecting an output destination from a list of possible destinations or to enter a destination address or location after customized information 242 is entered. In another exemplary embodiment, the user may enter an output destination prior to selecting common information 216. In yet another exemplary embodiment, the user is prompted to enter an output destination after selecting common information 216 but prior to entering customized information 242.

Once the output destination for customized file 230 has been chosen and the user is finished modifying the file, the user may create one or more additional customized files using the methods as described above. For instance, after a user is finished creating a first customized file 230, a copy of a second customizable file may be displayed on handheld computer 100, in which case the second customizable file includes only common information 216. The user may then add customized information, choose an output destination, and deliver the file to the chosen destination. The creation of additional customized files may take place either before or after the delivery of the first customized file 230 to its selected output destination. Thus, a user may create several customized files and deliver each to their respective destinations at the same time.

The manner of using handheld computer 100 to create automatically-generated customizable files 220 may vary, depending on the particular application program or other constraints or design choices. In an exemplary embodiment, the user creates a source file 210 in the same manner as one would create any other document. The user may then decide that the particular source file would be well-suited to customization, and would select an option to create a customizable file 220. Such an option may be denoted, “create customizable file” or the like. A user prompt would then be displayed on the screen instructing the user to highlight or otherwise mark the common information 216 for inclusion in the customizable file 220. After the selection is complete, customizable file 220 would be automatically generated, and the user would be prompted to enter any customized information 218. The user could then choose a recipient or output location to send the document. Following delivery of the document, another user prompt would ask the user whether another customizable file 220 should be created, and if the user answers in the affirmative, a customizable file identical to the first customizable file 220 would be created, and the process would repeat as desired by the user. Those of skill in the art will recognize that the order or content or implementation of these steps may be varied without departing from the scope of the described embodiment. For example, in another exemplary embodiment, the user may be prompted to choose an output location at any point in the process. In still another exemplary embodiment, the user may choose to create a customizable file 220 prior to creating a source file 210, and the user prompts would vary accordingly to provide the user with instructions for doing so.

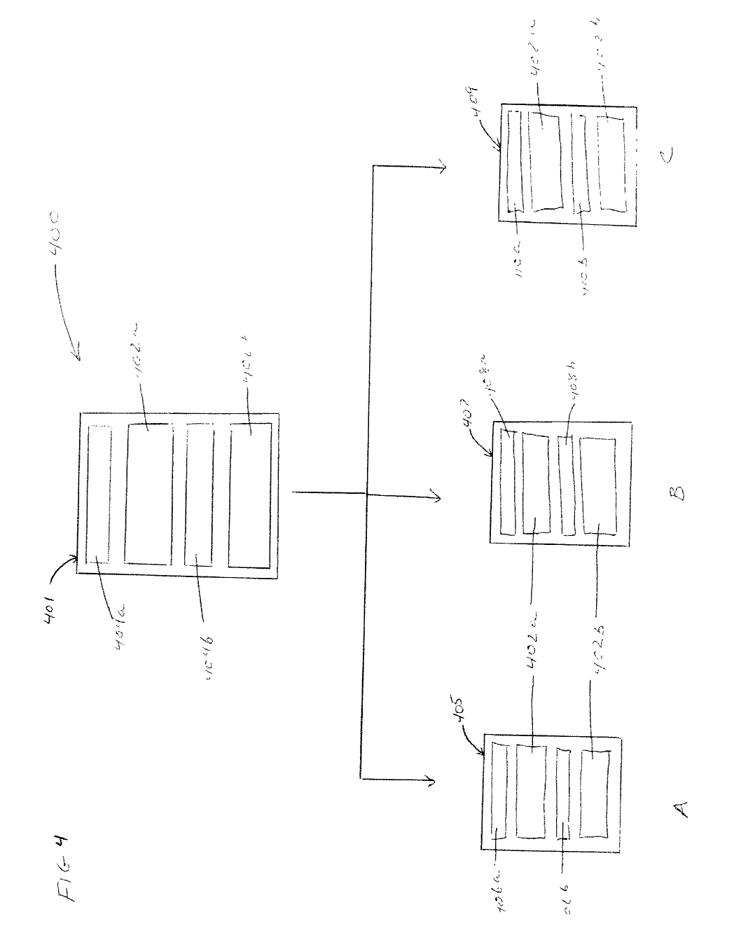

FIG. 4 is a flow diagram representative of the flow of information when a user creates multiple customized files. Source document 401 includes common information 402a, 402b and non-common information 404a, 404b. Three separate customized files 405, 407, and 409 are created by a user. Each of customized files 405, 407, and 409 include common information 402a, 402b. Additionally, file 405 includes customized information 406a, 406b; file 407 includes customized information 408a, 408b; and file 409 includes customized information 410a, 410b. Each of files 405, 407, and 409 may be sent to different recipients, and the customized information included in each file may be tailored to the relevant recipient.

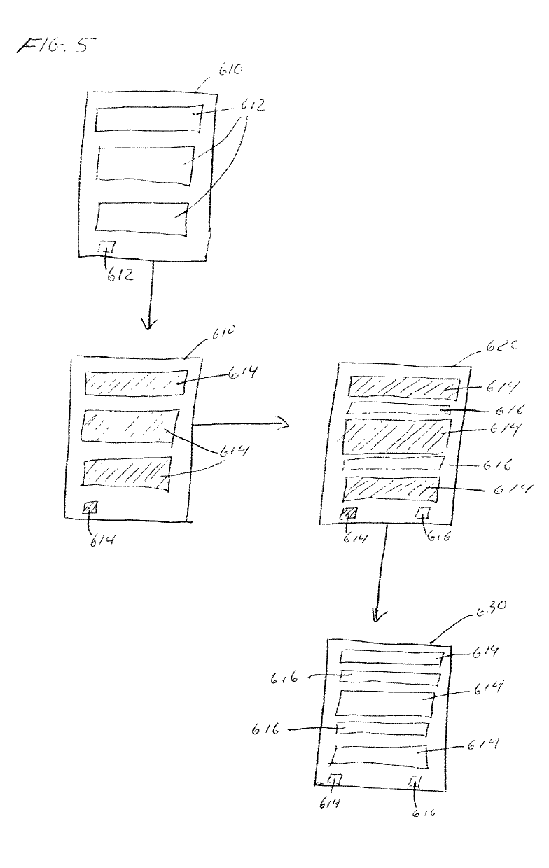

FIG. 5 is a flow diagram illustrating another exemplary embodiment for sending customized information to multiple recipients. A user of handheld computer 100 selects an option to create a source file, described herein as a template 610 including information 612. As described in detail above, template 610 may be any type of electronic document, and information 612 may be any type of electronic information, including but not limited to attached electronic files. A blank file appears on the display screen 114, and the user may enter information 612 in template 610.

After creating template 610, the user may choose to create customizable documents based on the template 610. In an exemplary embodiment, a user would select at least a part of information 612 in template 610 for inclusion in customizable document 620 as selected or common information 614. In another exemplary embodiment, the selection of all of information 612 in template 610 may be automatic. Thus, when a user wishes to create a customized document 630, all of information 612 in template 610 would automatically be transferred to a new customizable document 620. One advantageous feature of this embodiment is that a user need not perform the step of selecting which information should be transferred to customizable document 620. As illustrated in FIG. 5, when selected, information 614 may have a different appearance than it had in its unselected state, such as but not limited to bold, underlined, highlighted, or otherwise delineated information.

After common information 614 is transferred to customizable document 620, the user may add additional or customized information 616 to customizable document 620. Customized information 616 may be inserted anywhere in document 620. After adding customized information 616, customized document 630 includes both selected information 614 and customized information 616. As described above, all information in document 630 has the same appearance in an exemplary embodiment. Alternatively, common information 614 may have a different appearance from customized information 616.

The fully customized document 630 is then sent to a recipient, group of recipients, or storage location at an output destination. The output destination can be either remote from handheld computer 100 or a storage location within handheld computer 100. The output destination and recipient are chosen in the same manner as described above, and the user may send differing customized documents to a plurality of recipients at different output destinations.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A method of sending common information to multiple destination sources using a handheld computer, the method comprising:
selecting information in a source file;
storing the selected information in memory;
selecting a remote destination;
adding destination-specific information to the selected information; and
sending the selected and destination-specific information to the remote destination.

2. The method of claim 1, further comprising creating a customizable file and automatically moving the selected information from the memory to the customizable file.

3. The method of claim 1, wherein the source file is an electronic mail message created by the user.

4. The method of claim 1, wherein the source file is a template and the selecting information step is performed automatically.

5. The method of claim 1, wherein the selected information is electronic text.

6. The method of claim 1, wherein the selected information is an electronic file attachment.

7. The method of claim 6, wherein the electronic file attachment is at least one of an audio file, a video file, a spreadsheet file, a database file, a presentation file, and a text document file.

8. The method of claim 1, wherein selecting a remote destination includes entering a destination address.

9. The method of claim 8, wherein selecting a destination further comprises selecting the destination in response to a user prompt, wherein the user prompt automatically appears after the source file is created.

10. The method of claim 1, wherein selecting a destination comprises creating a group of destination addresses having a group name and selecting the group name.

11. The method of claim 10, wherein selecting a destination further comprises selecting the destination in response to a user prompt, wherein the user prompt automatically appears after the source file is created.

12. A method of customizing information contained in an electronic file using a handheld computer based on the intended recipient of the information, the method comprising:
selecting information in a first electronic document;
automatically generating a second electronic document, the second electronic document including the information selected from the first electronic document;
choosing an output destination for the second electronic document;
adding customized information to the second electronic document; and
delivering the second electronic document to the output destination.

13. The method of claim 12, wherein at least a portion of the customized information is automatically added to the second electronic document based on the recipient.

14. The method of claim 12, wherein the first electronic document is an electronic mail message.

15. The method of claim 12, wherein the first electronic document is a template document and the selection of information is performed automatically.

16. The method of claim 12, wherein the first electronic document is a text document.

17. The method of claim 12, wherein the selected information is electronic text.

18. The method of claim 12, wherein the selected information is an electronic file attachment.

19. The method of claim 18, wherein the electronic file attachment is at least one of an audio file, a video file, a spreadsheet file, a database file, a presentation file, and a text document file.

20. The method of claim 12, wherein choosing an output destination includes entering a destination address.

21. The method of claim 20, wherein selecting an output destination further comprises selecting the output destination in response to a user prompt, wherein the user prompt automatically appears after the first electronic document is created.

22. The method of claim 12, wherein choosing an output destination comprises creating a group of destination addresses having a group name and selecting the group name.

23. The method of claim 22, wherein selecting an output destination further comprises selecting the output destination in response to a user prompt, wherein the user prompt automatically appears after the first electronic document is created.

24. A method of conveying electronic information to members of a defined group using a handheld computer, the method comprising:
creating a distribution group including a plurality of recipients;
generating a first electronic file, the file including common information to be sent to at least one of the plurality of recipients;
choosing a first recipient from the plurality of recipients in response to a user prompt;
entering a first customized set of information in the electronic file tailored to the first recipient; and
sending the common information and the first customized set of information to the first recipient.

25. The method of claim 24, further comprising:
choosing a second recipient from the plurality of recipients in response to a user prompt;
entering a second customized set of information in a second electronic file tailored to the second recipient; and
sending the common information and the second customized set of information to the second recipient.

26. The method of claim 24, wherein the common information is stored in the dynamic memory of a handheld computer.

27. The method of claim 24, wherein the first and second electronic files are electronic mail messages.

28. The method of claim 24, wherein the first and second electronic files are text document files.

29. The method of claim 24, wherein the common information includes electronic text.

30. The method of claim 24, wherein the common information includes at least one electronic file attachment, and the electronic file attachment is at least one of an audio file, a video file, a spreadsheet file, a database file, a presentation file, and a text document file.

31. The method of claim 24, wherein the first customized set of information includes electronic text.

32. A handheld computer, comprising:
a processor;
a display coupled to the processor;
a memory coupled to the processor; and
a program running on the processor, the program configured to enable a user to create an electronic template document having a first set of information, the program configured to automatically transfer the first set of information into at least one destination-specific document, the program enabling the entry of destination-specific information into the at least one destination-specific document.

33. The handheld computer of claim 32, wherein the electronic template document is an electronic mail message.

34. The handheld computer of claim 32, wherein the first set of information includes electronic text.

35. The handheld computer of claim 32, wherein the first set of information includes an electronic file.

36. The handheld computer of claim 35, wherein the electronic file is at least one of an audio file, a video file, a spreadsheet file, a database file, a presentation file, and a text document file.

37. The handheld computer of claim 32, wherein the program is further configured to enable a user to send the destination-specific document to a remote location.

38. The handheld computer of claim 32, wherein the remote location is another handheld computer.
